(19) United States
(12) Patent Application Publication
(10) Pub. No.: US 2009/0193012 A1
(43) Pub. Date: Jul. 30, 2009

(54) Inheritance in a Search Index

(76) Inventor: James Charles Williams, Hawi, HI (US)

Correspondence Address: NORTH WEBER & BAUGH LLP, 2479 E. BAYSHORE ROAD, SUITE 707, PALO ALTO, CA, 94303, US

(21) Appl. No.: 12/022,097

(22) Filed: Jan. 29, 2008

(51) Int. Cl. G06F 17/30

(52) U.S. Cl. 707/5; 707/E17.005

(57) ABSTRACT

Embodiments of the present invention perform bulk updates of a search index with a representation that includes upward and downward inheritance. In various embodiments of the invention, a batched set of update requests is applied to a search index to modify existing indexed objects. A representation of the inheritance consequences of the updates is created, and that representation is used to construct a second batched set of update requests. The second batched set of update requests is applied to propagate the updates to the objects that have inheritance relationships to the modified existing indexed objects.

### BACKGROUND

A. Technical Field

The present invention pertains generally to data management architectures, and relates more particularly to devices and methods for performing inheritance operations in a search index.

B. Background of the Invention

Using an object-oriented representation for data has proved to be a valuable technique for many data processing and analysis applications. Object-oriented representations are ubiquitous, and provide the foundation for a wide variety of current applications that range, for example, from storage and networking infrastructures through databases and artificial intelligence systems. Several important computer languages (e.g., Java) are built upon object-oriented representations.

FIG. 1 illustrates a simple example of an object-oriented representation of a phylogeny of animals. The basic entity of an object-oriented representation is a data object that includes a set of attributes, or properties. Those skilled in the art recognize that there are many possible data object models, and that different object-oriented representations are based upon different fundamental object models. In FIG. 1, there are 3 objects (110, 120, and 130). Each object has a unique identifier (112, 122, and 132). In the object model used in this example, the attributes of each object are represented as a set of field-value pairs (114-116, 124-126, and 134-136). Each attribute corresponds to a field which has an identifier (e.g. a name) and an associated value.

The 3 objects (110, 120, and 130) illustrated in FIG. 1 are organized into an inheritance hierarchy. Object 110 is a parent node in the hierarchy, while Objects 120 and 130 are child nodes of Object 110. Attributes that belong to a parent node also belong to each of its child nodes; and the child nodes inherit attributes from their parent nodes. In the example, a mammal 120 and a bird 130 also are vertebrates 110 and both have inherited the “skeleton” field with a value of “backbone.” However, the mammal 120 and the bird 130 each have additional attributes that are not shared with the other objects; they each contain more specialized information than their parent.

The hierarchy illustrated in FIG. 1 is a tree structure; each child object (descendant hereafter) has one parent object (ancestor hereafter). The direction of inheritance is “downward” 105, where attributes are passed from the ancestor to the descendant(s). Those skilled in the art will recognize that there are inheritance hierarchies in which a descendant may have multiple ancestors. In this case, the inheritance hierarchy may be represented as a directed acyclic graph (“DAG”) where the arcs of the DAG represent the direction of inheritance.

Many types of applications, such as search engines, make use of a search index in order to perform information retrieval. A search index enables an application to search a large repository of items for specific content without having to scan every item in the repository. For example, a search index allows a search engine to search the email documents in a repository to find the documents containing specific content by executing queries or other types of requests that contain key words and/or phrases associated with the content.

Since a search index represents the information in a repository, the search index should be updated whenever the information in the repository changes. The cost (in terms of computing resources and time) of updating a search index may be very high, especially if the information repository is large and/or is changing often. The consumption of computing resources during an update may reduce the performance of an application and introduce significant delays in the operation of the application.

### SUMMARY OF THE INVENTION

Embodiments of the present invention perform bulk updates of a search index with a representation that includes upward and downward inheritance. In various embodiments of the invention, a batched set of update requests is applied to a search index to modify existing indexed objects. A representation of the inheritance consequences of the updates is created, and that representation is used to construct a second batched set of update requests. The second batched set of update requests is applied to propagate the updates to the objects that have inheritance relationships to the modified existing indexed objects.

In embodiments, a method for updating a search index may comprise executing a first set of update requests that comprise at least one transformation, the set of update requests identifying a first set of objects to be updated within the search index; identifying a second set of objects based at least in part on an inheritance relationship with the first set of objects, associating at least one transformation with the second set of objects; generating a second set of update requests comprising at least one transformation and the second set of objects; and executing the second set of update requests within the search index.

In embodiments, updating a search index further comprises the step of creating a representation based at least in part on the identified second set of objects and at least one transformation. The representation may comprise a universe set that comprises a first object, related through inheritance to an updated object within the first set of objects that includes an inherited field to be modified; an upward sources set comprising a second object within the first set of objects that includes a first modified field that is inherited by at least one ancestor object; and an upward sources set comprising a third object within the first set of objects that includes a first modified field that is inherited by at least one descendant object.

In embodiments, the step of generating the second set of update requests comprises building a transformer for an inherited field of at least one object within the second set of objects. In embodiments, the transformer is constructed for a value within the inherited field, the value being identified by a source facet pointing to an object within the first set of objects. In embodiments, the search index comprises a plurality of subindexes and at least one object is in a subindex within the plurality of subindexes. In embodiments, the transformer for the object is associated with the subindex.

In embodiments, a method for updating a search index may comprise accessing an object having a field to-be-updated; identifying a plurality of objects within the search index, the plurality of objects having a first set of common fields with the field to-be-updated; determining a set of source objects within the plurality of objects, the set having an inheritance relationship with the accessed object and a second set of fields common with the field to-be-updated; and modifying the field to-be-updated based on values within the second set of fields. In embodiments, the search index may comprise a plurality of subindexes.

In embodiments, the step of determining the set of source objects comprises examining a source objects field within the accessed object. In embodiments, a value in the source objects field is a unique identifier of a source object having an inheritance relationship with the accessed object.

In embodiments, a method for adding an inheritance relationship between a first object and a second object within a search index may comprise copying a first field and value within the first object to a second field within the second object; and creating an inheritable field in the second object, the inheritable field identifying an inheritance relationship between the first field and the second field.

In embodiments, the first object may be a tree comprising a third object and a fourth object with an inheritance relationship between the third object and the fourth object. In embodiments, the third object also has an inheritance relationship with the second object.

In embodiments, a method for removing an inheritance relationship between a first object and a second object within a search index may comprise removing a first field from the first object, the first field having been inherited from a second field within the second object; and removing an inheritable field in the first object, the inheritable field indentifying an inheritance relationship between the first field and the second field. In embodiments, removing the inheritance relationship comprises removing a value from the first field and from the inheritable field, the value having been inherited from the second object. In embodiments, the value within the inheritable field is associated with a source facet that identifies the second object.

In embodiments, a method for applying a modification to a first field of a first object with a search index may comprise applying the modification to the first field, determining an inheritance relationship between the first field and a second field within a second object within the search index by examining an inheritable field within the first object, the inheritable field being associated with the first field; and applying the modification to the second field. In embodiments, the modification is adding a value to the first field. In embodiments, the modification is removing a value from the first field. In embodiments, the modification is changing a value within the first field.

In embodiments, a system for updating a search index may comprise an object updater that applies at least one modification to a first object within the search index; and an update propagator that identifies a set of objects having an inheritance relationship to the first object and a set of modifications comprising at least one modification, the set of modifications to be applied to at least some of the objects within the set of objects. In embodiments, the update propagator may be a join query processor. In embodiments, the update propagator maintains relationships across the set of objects.

In embodiments, a system for maintaining relationships across a plurality of objects within a search index may comprise a new object inserter that adds an inheritance relationship between a first object and a second object within the search index; an existing object remover that removes an inheritance relationship between the first object and the second object; and an inheritable field modifier that applies a modification to a first field of the first object.

Some features and advantages of the invention have been generally described in this summary section; however, additional features, advantages, and embodiments are presented herein or will be apparent to one of ordinary skill in the art in view of the drawings, specification, and claims hereof. Accordingly, it should be understood that the scope of the invention shall not be limited by the particular embodiments disclosed in this summary section.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates an example of a simple inheritance hierarchy.

FIG. 2A illustrates an example of the inheritance hierarchy between an email object and a document attachment object according to various embodiments of the invention.

FIG. 2B illustrates another example of the inheritance hierarchy between two email objects and a document attachment object according to various embodiments of the invention.

FIG. 3 illustrates an example of the object representations of two email objects and a document attachment object within an inheritance hierarchy according to various embodiments of the invention.

FIG. 4A depicts a block diagram of a system for performing a batch update to a search index organized as an inheritance hierarchy according to various embodiments of the invention.

FIG. 4B depicts a block diagram of an update propagator based on pull-type inheritance according to various embodiments of the invention.

FIG. 4C depicts a block diagram of an update propagator based on push-type inheritance according to various embodiments of the invention.

FIG. 5 depicts a method for propagating updates within a search index based upon pull-type inheritance according to various embodiments of the invention.

FIG. 6 depicts a method for adding a new object to a search index that may have ancestors and/or descendants according to various embodiments of the invention.

FIG. 7 depicts a method to remove an object from a search index that may have ancestors and/or descendants according to various embodiments of the invention.

FIG. 8 depicts a method to add or delete a new value to/from an inheritable field of an object within a search index according to various embodiments of the invention.

FIG. 9 depicts a method to process a batch of updates to existing objects within a search index according to various embodiments of the invention.

FIG. 10 depicts a method to build a representation of the required changes to be made to the ancestors and descendants of updated objects according to various embodiments of the invention.

FIG. 11 depicts a method to perform a set of updates to be made to the ancestors and descendants of updated objects according to various embodiments of the invention.

FIG. 12 depicts a block diagram of a computing system according to various embodiments of the invention.

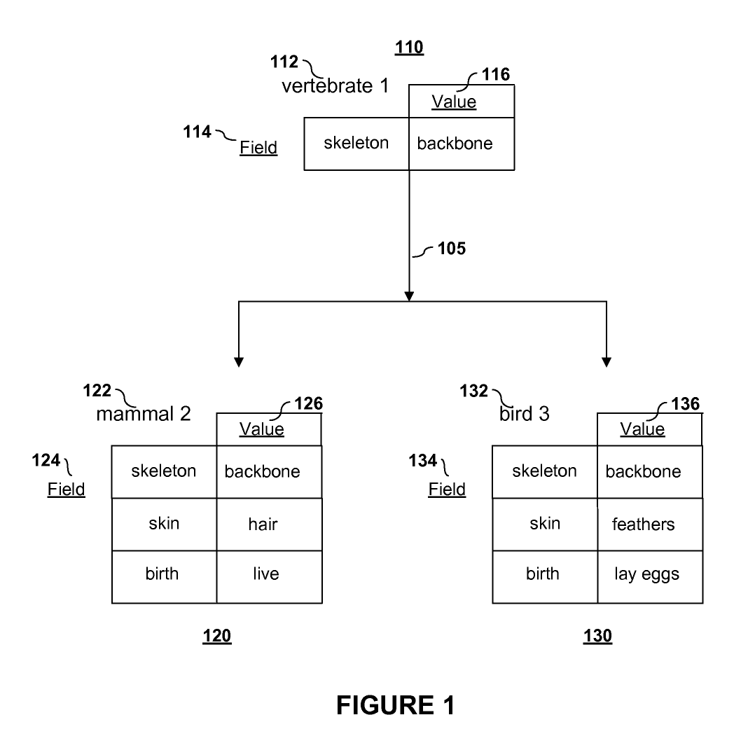

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be performed in a variety of mediums, including software, hardware, or firmware, or a combination thereof. Accordingly, the flow charts described below are illustrative of specific embodiments of the invention and are meant to avoid obscuring the invention.

Components, or modules, shown in block diagrams are illustrative of exemplary embodiments of the invention and are meant to avoid obscuring the invention. It shall also be understood that throughout this discussion that components may be described as separate functional units, which may comprise sub-units, but those skilled in the art will recognize that the various components, or portions thereof, may be divided into separate components or may be integrated together, including integrated within a single system or component.

Furthermore, connections between components within the figures are not intended to be limited to direct connections. Rather, data between these components may be modified, re-formatted, or otherwise changed by intermediary components. Also, additional or fewer connections may be used. It shall also be noted that the terms “coupled” or “communicatively coupled” shall be understood to include direct connections, indirect connections through one or more intermediary devices, and wireless connections.

Reference in the specification to “one embodiment,” “preferred embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

A. Inheritance in a Search Index Representation

A search index provides content-based access to objects in a repository. Emails are an example of objects that are useful to search. Emails have a natural representation that may use inheritance; in embodiments, a search index representing a repository of emails may have a representation that includes inheritance.

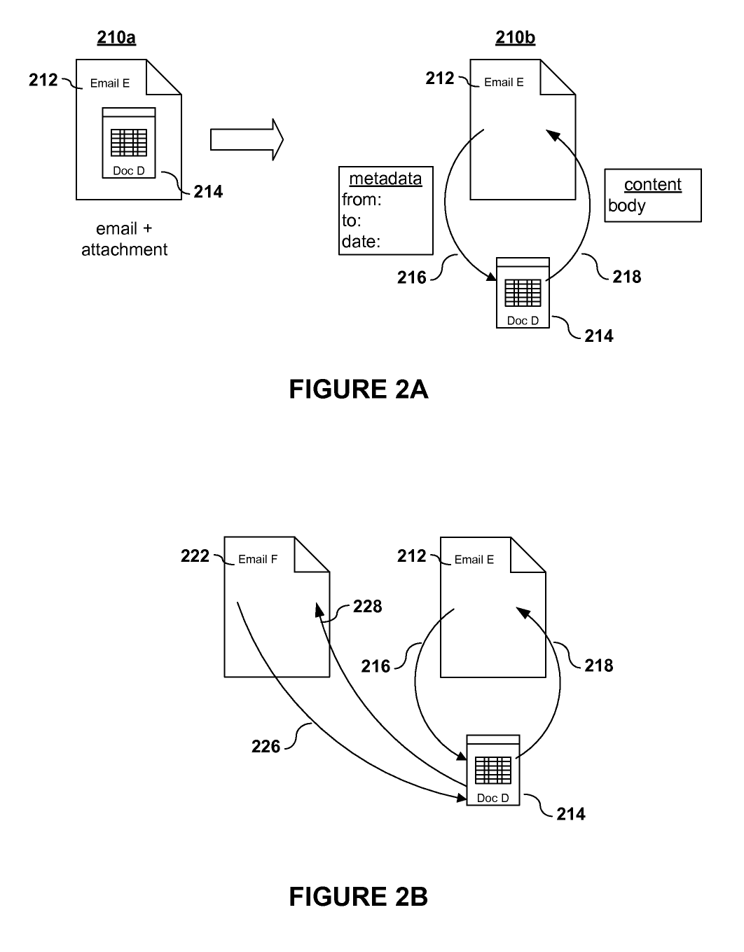

FIG. 2A illustrates exemplary inheritance relationships among email objects according to various embodiments of the invention. Object view 210a illustrates an email E 212 that attaches a document D 214. The inheritance relationships between email E 212 and document D 214 are illustrated in object view 210b. Document D 214 may naturally inherit metadata properties (e.g. to, from, and date fields) from email E 212. In this relationship, the inheritance is “downward” 216, since attributes are being passed from the ancestor (email E 212) to the descendant (document D 214). The inheritance relationship between email E 212 and document D 214 is a two-way inheritance relationship, because the ancestor 212 inherits attributes (e.g. the body field) from the descendant 214. This inheritance relationship is “upward” 218. The inheritance structure illustrated in 210b is a tree with two-way inheritance because the descendant 214 has only one ancestor 212.

For purposes of illustration, an exemplary scenario of using a search index based upon the example email inheritance relationship is illustrated in FIG. 2A. If John sent email E 212 to Mary on Jun. 1, 2007, then we can conclude that John also sent document D 214 to Mary on Jun. 1, 2007 because document D 214 has inherited the metadata properties of email E 212 such as the from, to, and date fields. If email E 212 content contains the word “contract” and document D 214 contains the phrase “Acme, Inc.” then a search expression<“contract” “Acme, Inc.”>should match email E 212 since email E 212 includes the inherited body field of document D 214 as part of its content.

FIG. 2B illustrates an example of an inheritance hierarchy formed after the addition of a second email F 222 that also attaches document D 214 according to various embodiments of the invention. Email F 222 inherits the content of its descendant document D 214 through upward inheritance 228. Document D 214 now has two ancestors, email E 212 and email F 222, and inherits metadata from both ancestors (216, 226). The inheritance hierarchy illustrated in FIG. 2B is represented as a directed acyclic graph (DAG) since the descendant document D 214 has multiple ancestors (email E 212 and email F 222).

In various embodiments, inheritance hierarchies of email objects may be arbitrarily broad and deep. For example, an email E may attach an email E1, a document D, and a zip file Z, while email E1 may attach another document D1 and another zip file Z2. Document D may contain subdocuments D2 and D3, and zip file Z may contain many documents and subarchives. These relationships may be represented in a DAG where metadata properties inherit “down” and content properties inherit “up.”

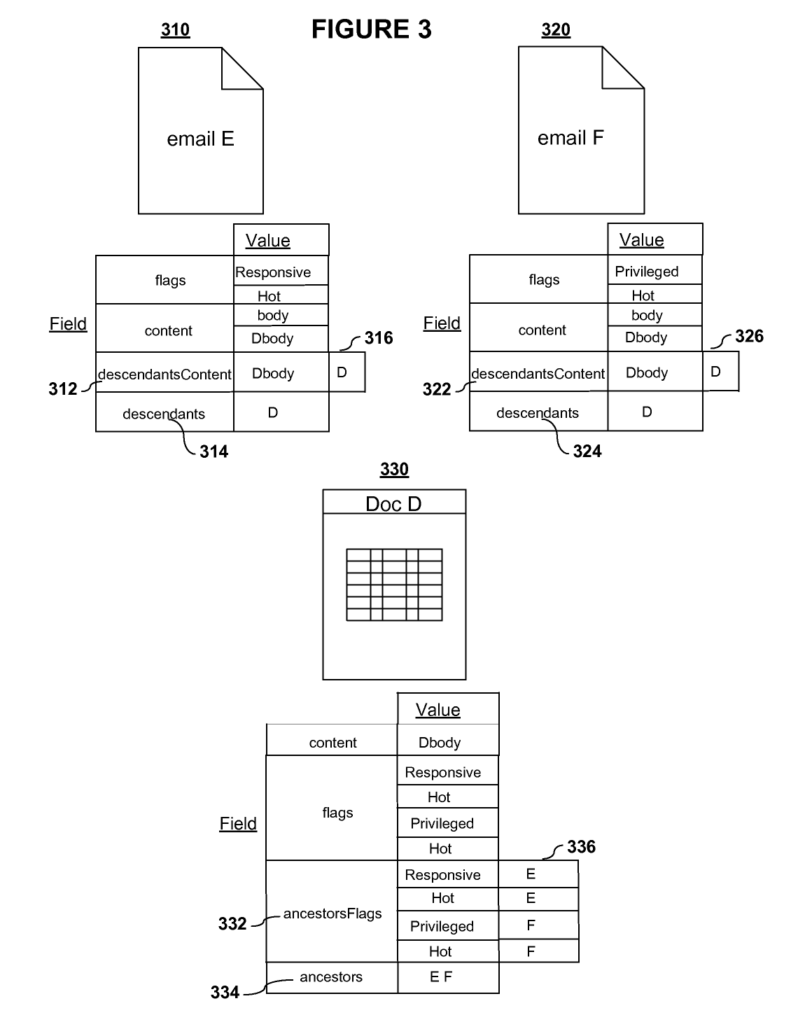

FIG. 3 illustrates an exemplary portion of the object representation of the email objects depicted in the inheritance hierarchy of FIG. 2B according to various embodiments of the invention. Email E 212 is represented in object view 310, email F 222 is represented in object view 320, and document D 214 is represented in object view 330. In each object view, selected attributes of each object are represented as field-value pairs.

In various embodiments of the invention, objects within an inheritance hierarchy may be given attributes that correspond to inheritance relationships. An attribute that is inherited from either an ancestor or descendant is termed an “inheritable field.” Turning to the example in FIG. 3, the “flags” field of the email objects 310 and 320 is not inheritable but the “content” field is inheritable. In the document object 330, the “content” field is not inheritable but the “flags” field is inheritable.

In various embodiments, each object may have additional “ancestors” and “descendants” fields that, together, represent the transitive closure of parents and children. The value(s) in each of these fields may be the unique object IDs of ancestors and/or descendants, permitting those objects to be located by reference. In the example in FIG. 3, the objects 310 and 320 each have a “descendants” field (314, 324) with the value of “D,” the ID of the descendant of each object. Object 330 has an “ancestors” field with the values “E” and “F,” the IDs of both ancestors of the object.

In various embodiments of the invention, an additional field may be created on an object for each of its inheritable fields. If the values in an inheritable field F are inherited downward, the additional field is named “ancestorsF,” and if the values in F are inherited upward, the additional field is named “descendantsF.” The objects 310 and 320 each have an additional field “descendantsContent” (312, 322) that corresponds to their inheritable field “content.” The object 330 has an additional field named “ancestorsFlags” that corresponds to its inheritable “flags” field. In embodiments, the value of an inherited field of an object is the union of all of the values that the object has inherited for that field. The object 330 has inherited the “flags” values of “Responsive” and “Hot” from the object 310, and the “flags” values of “Privileged” and “Hot” from the object 320. Therefore, the value of the “flags” and “ancestorsFlags” fields is the set {“Responsive” “Hot” “Privileged” “Hot”}. Those skilled in the art will recognize that there is a variety of possible policies for determining an inherited value for an inheritable field of an object with multiple ancestors or descendants, and that the choice of a policy is not critical to the invention.

A search index representation typically is designed to enable fast access to improve the performance of executing requests or queries against the index. When documents are added or removed from a repository, or when content is modified, a search index of the repository should be updated to reflect the changes. Updating a search index may be resource intensive since the operation may involve re-analysis and re-writing indexes. Changes to search index representations that include inheritance may include additional costs because change(s) to an object also may need to be propagated to its ancestors/descendants. Identifying, examining, and updating an object's ancestors/descendants are examples of operations that may add cost to an update.

In various embodiments of the invention, storage of each object's inheritance relationships within its set of attributes may facilitate propagation of changes throughout an inheritance hierarchy because lookups to find ancestors and descendants are not required. In embodiments, propagation of changes to field values may be further enabled by adding a “source facet” to each value in an ancestorsF or descendantsF field. A facet, a component of an object model, is an attribute that may be associated with a field value. Those skilled in the art will recognize that the selection of a particular object model and the choice to use facets is not critical to the invention. A source facet value may be the ID of the ancestor/descendant from which the value was inherited. Source facets (316, 326) are on the value of the descendantsContent fields of object 310 and 320, and source facets 336 are on the values of the ancestorsFlags field of object 330.

In various embodiments of the invention, source facets support efficient removal of an inherited value when it no longer can be inherited. Turning again to the example in FIG. 3, suppose that, in an update, both values (“Responsive” and “Hot”) were removed from email E 310. As a result, the “ancestorsFlags” 332 and “flags” fields of document D 330 would no longer contain the value “Responsive” since that value was solely inherited from email E 310, but the value “Hot” would remain because it continues to be inherited from email F 320. Using source facets, removal of a value from a field enables removal of the corresponding faceted inherited value without requiring an additional check whether removed values remain inheritable from an alternative source.

In various embodiments of the invention, the cost of using source facets may be optimized by not attaching them to values which are known a priori not to change. Two examples of such values are 1) A value that cannot be changed once it's set (e.g. the to, from, and cc addresses of an email once it has been sent); and 2) A value that can change (i.e. is mutable), but it is guaranteed that if the value is inherited by any descendants, they will not also inherit it from another ancestor. In embodiments, an example of such a value is topics. Every item (e.g. an email document) is assigned a single topic. Topics inherit upward, so, for example, if a document is about topic T1 and it is attached to an email E about topic T2, then descendantTopics on email E contains topic T1 to represent the fact that email E is also about topic T1 in its attachment. Topics are only removed from a document when they are removed from all documents in the system. Thus, whenever a topic is deleted from any document it is deleted from all documents in the system. A deleted topic T2, therefore, also can be safely deleted from all descendantTopics fields of all documents since no descendantTopics field can inherit topic T2 from any other descendant document because topic T2 has been deleted from all documents in the system.

One specific application of the present invention is its use in updating a search index having a representation that includes inheritance.

B. System Implementations

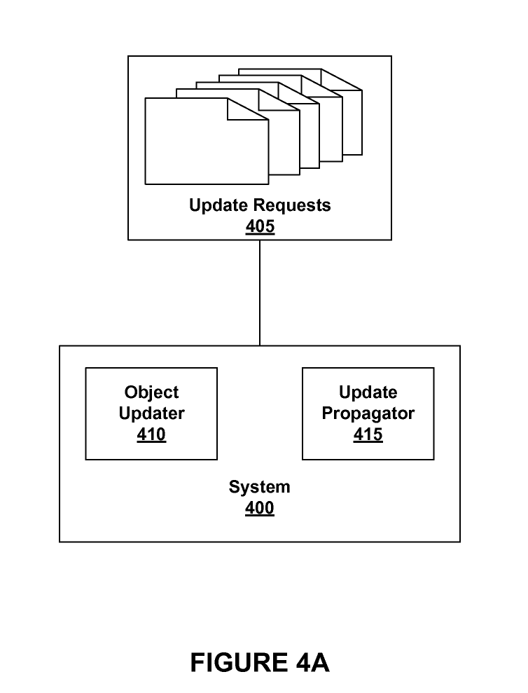

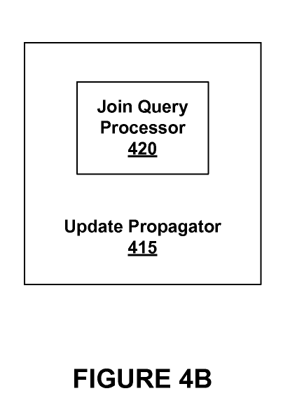

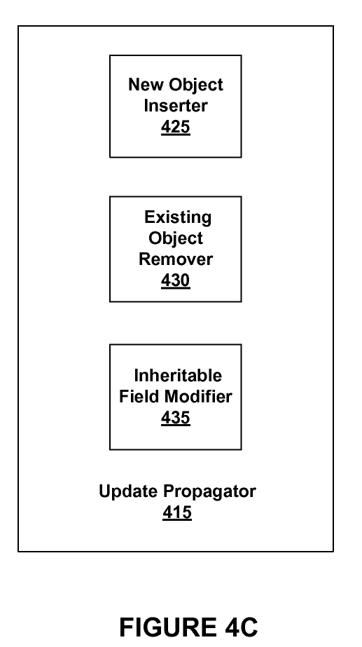

FIG. 4A depicts a system 400 for performing a bulk update of a search index having a representation that includes inheritance according to various embodiments of the invention. System 400 comprises an object updater 410 and an update propagator 515.

In various embodiments of the invention, an update request is a set of transformations that add or delete values and/or fields in existing objects. Typically, search indexes are not optimized for updates (unlike databases, which typically are optimized for updates) so those skilled in the art recognize that it is more efficient to assemble a batch of update requests 405 and apply them to the search index in a single bulk update operation.

In various embodiments, object updater 410 receives a set of transformations and an object, and applies the set of transformations to the fields and/or values of the object as described in U.S. patent application Ser. No. 12/022,073, entitled “Bulk Search Index Updates,” filed Jan. 29, 2008, which is herein incorporated by reference in its entirety

When there are changes to values in any field of an object, those changes may be propagated to any object(s) that inherit the values. Update propagator 415 identifies an updated object's ancestors/descendants and propagates the updates to the ancestors/descendants if necessary according to various embodiments of the invention.

Those skilled in the art will recognize that there are different schemes that may be employed for propagation of updates, and that the choice of a scheme may be based on search index characteristics such as overall size of the search index and typical number of ancestors/descendants of an object in the search index. One type of propagation scheme is “pull-based inheritance” in which the value of a field of an object is determined at the time the object is accessed by looking at all potentially inherited values. In embodiments, this scheme would use the “descendants” and “ancestors” fields of an updated object to find the set of objects having inheritance relationships to the updated object.

An alternative type of propagation scheme is “push-based inheritance” in which the update of a field is propagated to all objects that inherit that field. Push-based inheritance requires maintenance of the correct values for inherited fields under arbitrary changes to the indexed objects. Those skilled in the art will recognize that, when optimizing a search index representation, the selection of pull-based inheritance generally results in more cost-intensive (and thus slower performance) access times but less cost-intensive (and thus faster performance) updates, while the selection of push-based inheritance generally results in faster performance access times and slower performance updates.

FIG. 4B depicts an update propagator 415 that comprises a join query processor 420 according to various embodiments of the invention. Join query processor 420 implements pull-based inheritance in connection with joins applied to the “descendants” and “ancestors” fields of an object.

For purposes of illustration, the object representations depicted in FIG. 3 can be used in an exemplary scenario that applies pull-based inheritance in connection with joins. In the scenario, a join query may be used to determine if document D 330 has inherited a Responsive flag from any source.

To obtain a result set of all the objects having an ancestor with a “flags” field value of “Responsive,” the following join query may be executed:

ancestors:(flags:Responsive)

This join query may be implemented with two queries:

1. Perform the inner query to find the IDs of all objects with a value “Responsive” in the “flags” field (should yield a result list ID1, ID2, . . . , IDn)

2. Perform the outer query, substituting the result list for the inner query, e.g. ancestors: (ID1, ID2, . . . , IDn)

In the scenario, the object ID “D” would have inherited a Responsive flag if the result set of the outer query (2) was not empty.

In embodiments, pull-based inheritance in connection with joins does not require storage of inherited field values or source facets. Pull-based inheritance in connection with joins is based on the natural join fields “ancestors” and “descendants” that may be present in the object model used in a search index representation.

FIG. 4B depicts an update propagator 415 that comprises a new object inserter 420, an existing object remover 430, an ancestor/descendant link modifier 435, and an inheritable field modifier 440 according to various embodiments of the invention.

The new object inserter 425 implements push-based inheritance when a new object (for example, a new object A) is added to the index and made an ancestor or descendant of an existing object (for example, existing object O). In various embodiments, values from each upwardly inheritable field F of the existing object O are propagated to each descendantF field of new object A, while values from each downwardly inheritable field G of new object A are propagated to each ancestorG field of the existing object O.

In various embodiments, new object inserter 425 may add a tree inheritance hierarchy of objects (“tree”) to an index. An example of a tree is the email and document attachment (210a and 210b) illustrated in FIG. 2. If the tree contains only new objects, local (within-tree) inheritance is implemented and then the tree is added to an index in the same way as described for adding a new single object. Integrating a tree into an index becomes more complex if the objects within the tree have inheritance relationships with existing objects within the index. If, for example, email E 212 were a new object that was given a descendant of an existing object O, the values of the upwardly inheritable fields of O would be propagated to the descendantF fields of email E 212 before the document D 214 is made a descendant of email E 212 within the tree in order to insure that document D 214 would receive all of the inheritable fields of email E 212.

The existing object remover 430 implements push-based inheritance when an inheritance relationship between objects is removed. In various embodiments, source facets on values in inheritable fields may be used to facilitate removal of inherited values due to the relationship being removed. Those skilled in the art will recognize that if source facets are not present in an object representation, propagating the removal of inherited values may be a costly operation because it would require lookup of potential sources from which each value might be inherited.

In various embodiments of the invention, inheritable field modifier 435 implements push-based inheritance when values are added or deleted from an inheritable field of an existing object O either because O's ancestors or descendants are added/removed, or as a result of a modification of O itself. In embodiments, addition or deletion of a value to an inherited field F of O may be implemented by propagating that addition or deletion to the descendantF fields of O's ancestors if F is upwardly inherited, or by propagating that addition or deletion to the ancestorF fields of O's descendants if F is downwardly inherited.

C. Methods for Inheritance Updates of Existing Indexed Objects

When there are changes to values in any field of an object, those changes may be propagated to any object(s) that inherit the values. Methods for propagating those changes may be implemented as embodiments of update propagator 415.

Those skilled in the art will recognize that there are different schemes that may be employed for propagation of updates, and that the choice of a scheme may be based on search index characteristics such as overall size of the search index and typical number of ancestors/descendants of an object in the search index. One type of propagation scheme is “pull-based inheritance” in which the value of a field of an object is determined at the time the object is accessed by looking at all potentially inherited values. In embodiments, this scheme would use the “descendants” and “ancestors” fields of an updated object to find the set of objects having inheritance relationships to the updated object.

An alternative type of propagation scheme is “push-based inheritance” in which the update of a field is propagated to all objects that inherit that field. Push-based inheritance requires maintenance of the correct values for inherited fields under arbitrary changes to the indexed objects. Those skilled in the art will recognize that, when optimizing a search index representation, the selection of pull-based inheritance generally results in more cost-intensive (and thus slower performance) access times but less cost-intensive (and thus faster performance) updates, while the selection of push-based inheritance generally results in faster performance access times and slower performance updates.

1. Update Propagation Using Pull-Based Inheritance

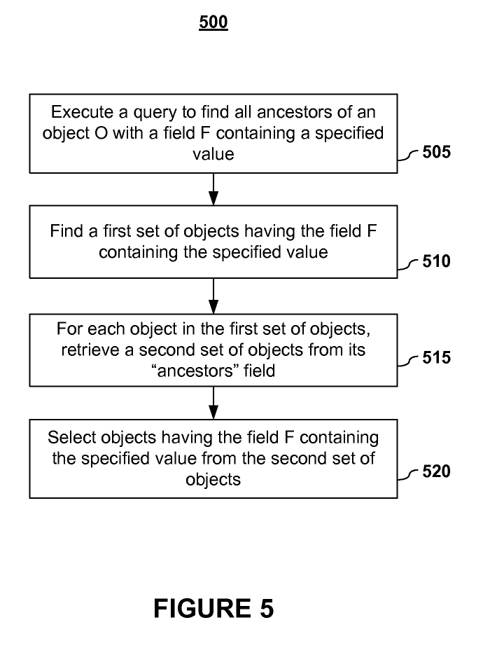

FIG. 5 depicts a method 500, independent of structure, for propagating updates using pull-based inheritance in conjunction with joins according to various embodiments of the invention. Method 500 may be implemented by embodiments of join query processor 420.

In embodiments, pull-based inheritance in connection with joins does not require an object representation to include storage of inherited field values or source facets. Pull-based inheritance in connection with joins is based on the natural join fields “ancestors” and “descendants” that may be present in the object model used in a search index representation.

For purposes of illustration, the object representations depicted in FIG. 3 can be used in an exemplary scenario that applies pull-based inheritance in connection with joins. In the scenario, a join query may be used to determine if document D 330 has inherited a Responsive flag from any source. To obtain a result set of all the objects having an ancestor with a “flags” field value of “Responsive,” the following join query may be executed 505:

ancestors:(flags:Responsive)

This join query may be implemented with two queries:

1. Perform the inner query 510 to find the IDs of all objects with a value “Responsive” in the “flags” field (should yield a result list ID1, ID2, . . . , IDn)

2. Perform the outer query 520, substituting the result list for the inner query 515, e.g. ancestors: (ID1, ID2, . . . , IDn)

In the scenario, the object ID “D” would have inherited a Responsive flag if the result set of the outer query (2) was not empty.

Those skilled in the art will recognize that the performance cost of method 500 becomes large as the number of results of the inner query 510 becomes large.

2. Update Propagation Using Push-Based Inheritance

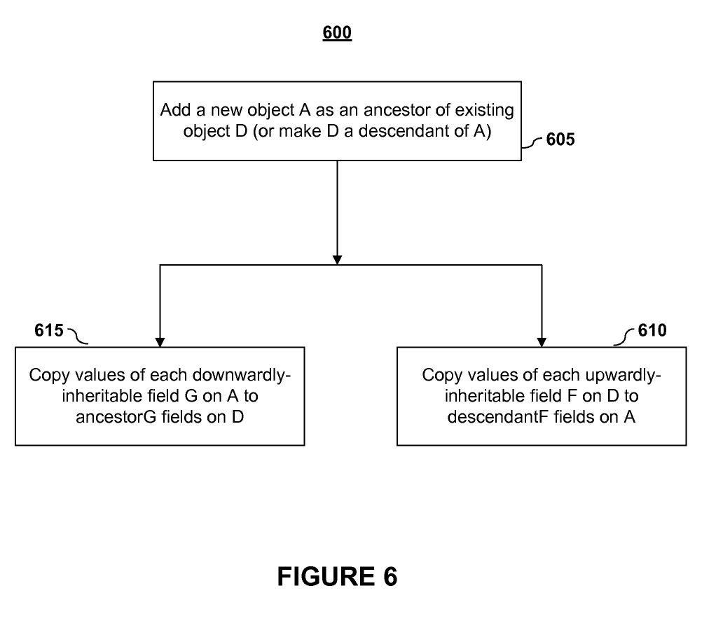

FIG. 6 depicts a method 600, independent of structure, for adding a new object to a search index using push-based inheritance according to various embodiments of the invention. Method 600 may be implemented in embodiments of new object inserter 425.

Method 600 may implement propagation of values when a new object A is added to the index and made an ancestor or descendant of an existing object D 605. In various embodiments, values from each upwardly inheritable field F of the existing object D are propagated to each descendantF field of A 610, while values from each downwardly inheritable field G of A are propagated to each ancestorG field of the existing object D 615.

In various embodiments, a tree inheritance hierarchy of objects (“tree”) may be added to an index as the ancestor or descendant of an existing object. An example of a tree is the email and document attachment (210a and 210b) illustrated in FIG. 2. If the tree contains only new objects, local (within-tree) inheritance is implemented and then the tree is added to an index in the same way as described for adding a new single object. Integrating a tree into an index becomes more complex if the objects within the tree have separate inheritance relationships with existing objects within the index. If, for example, email E 212 was a new object that was given a descendant of an existing object O, the values of the upwardly inheritable fields of O would be propagated to the descendantF fields of email E 212 before the document D 214 is made a descendant of email E 212 within the tree in order to insure that document D 214 would receive all of the inheritable fields of email E 212.

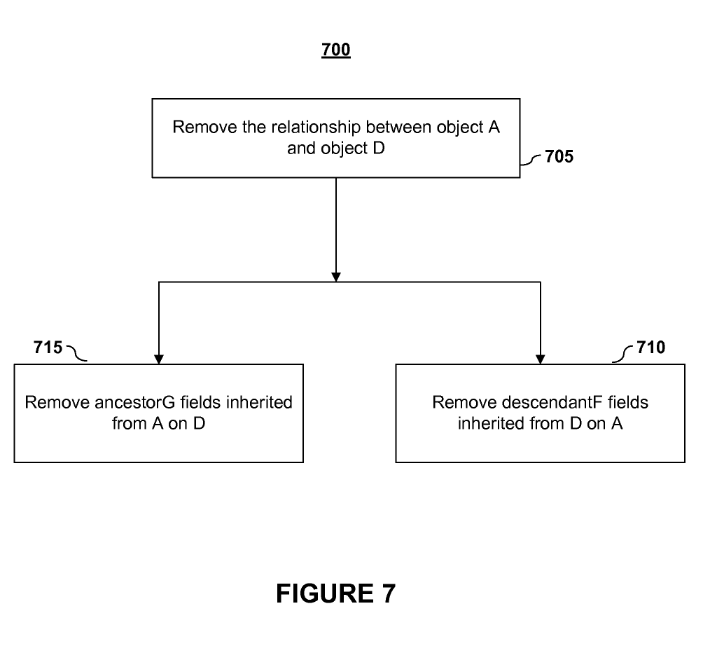

FIG. 7 depicts a method 700, independent of structure, for using push-based inheritance when removing the relationship between an object and its ancestors and/or descendants according to various embodiments of the invention. Method 700 may be implemented in embodiments of existing object remover 430.

In various embodiments, removing an object A also removes its relationship with existing object D 705. Removing the relationship between A and its descendant D removes the ancestorG fields inherited from A on D 715. Removing the relationship between A and its ancestor D removes the descendantF fields inherited from D on A 710.

In various embodiments, source facets on values in inheritable fields may be used to facilitate removal of inherited values due to the relationship being removed. Those skilled in the art will recognize that if source facets are not present in an object representation, this operation may be costly because it would require lookup of potential sources from which each value might be inherited.

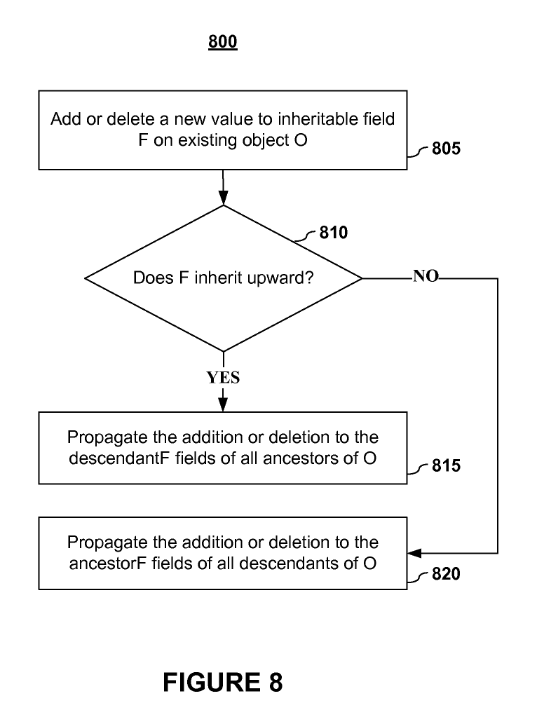

FIG. 8 depicts a method 800, independent of structure, for using push-based inheritance when modifying the fields of an existing object according to various embodiments of the invention. Method 800 may be implemented in embodiments of inheritable field modifier 435.

Values may be added or deleted from an inheritable field of an existing object O either because O's ancestors or descendants are added/removed, or as a result of a modification of O itself 805. In various embodiments of the invention, addition or deletion of a value to an inherited field F of O may be implemented by propagating that addition or deletion to the descendantF fields of O's ancestors 815 if F is upwardly inherited 810, or by propagating that addition or deletion to the ancestorF fields of O's descendants 820 if F is downwardly inherited 810.

D. Method for Bulk Inheritance Updating of Existing Indexed Objects

As previously mentioned, search indexes are not optimized for updates (unlike databases, which typically are optimized for updates) so those skilled in the art recognize that it is more efficient to assemble a batch of update requests 405 and apply them to the search index in a single bulk update operation.

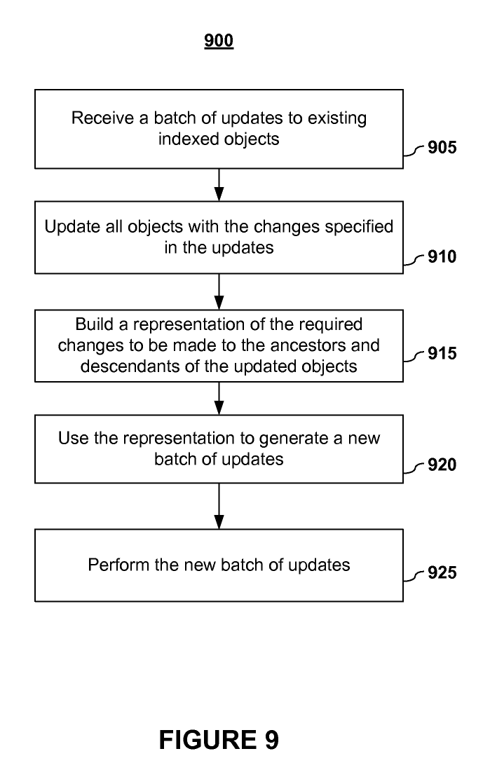

FIG. 9 depicts a method 900, independent of structure, for performing a bulk update of a search index having a representation that includes inheritance according to various embodiments of the invention. Method 900 comprises the steps of receiving a batch of updates to existing indexed object 905; updating all objects with the changes specified in the updates 910; building a representation of the required changes to be made to the ancestors and descendants of the updated objects 915; using the representation to generate a new batch of updates 920; and performing the new batch of updates 925. Method 900 may be implemented by embodiments of system 400.

In embodiments, an update request is a set of transformations. A transformation may be represented as a “transformer” in the form of <set of affected object IDs>, <specification of values to add or remove from a single field and/or an arbitrary algorithm that is applied to the values>. A transformer is applied to the specified values for the field on each object in the set of affected objects 910. Step 910 may be implemented by embodiments of object updater 410 in system 400.

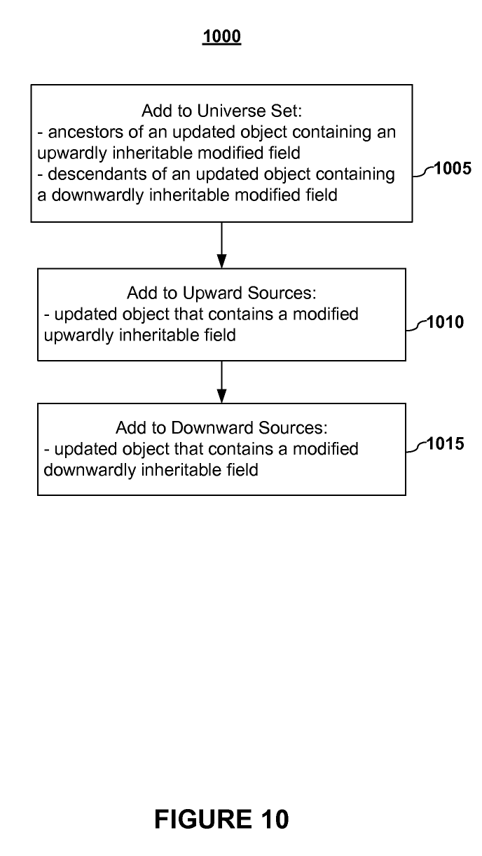

In embodiments, a representation of inheritance consequences resulting from updating an object may be built incrementally as the update requests are being executed 915. FIG. 10 depicts a method 1000 for incrementally building a representation of inheritance consequences of an update of an object according to various embodiments of the invention. Method 1000 may be implemented as step 915 in embodiments of method 900.

In embodiments, a representation of inheritance consequences may be composed of three parts:

1) A Universe Set comprising the set of IDs of objects containing inherited values affected by an update request. The ancestors of an updated object containing an upwardly inheritable modified field and/or the descendants of an updated object containing a downwardly inheritable modified field may be added to the Universe Set 1005.

2) A set of Upward Sources comprising the set of IDs of updated objects that contain a modified upwardly inheritable field. If the updated object contains a modified upwardly inheritable field, its ID is added to this set of Upward Sources 1010.

3) A set of Downward Sources comprising the set of IDs of updated objects that contain a modified downwardly inheritable field. If the updated object contains a modified downwardly inheritable field, its ID is added to this set of Downward Sources 1015.

Those skilled in the art will recognize that a variety of data structures exist for storage of the representation of inheritance consequences, and that selection of a data structure is not critical to the invention.

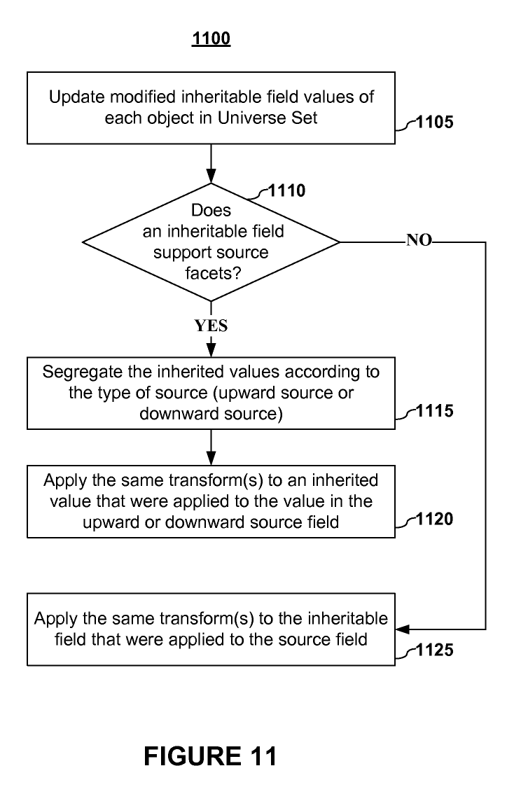

FIG. 11 depicts a method 1100 for using a representation of inheritance consequences to update the objects in the Universe Set according to various embodiments of the invention. Method 1100 may be implemented as steps 920 and 925 in embodiments of method 900.

In embodiments, the changes to apply to each object in the Universe Set may be specified by a custom “inherited value transformer” that operates on each inheritable field corresponding to a modified inheritable field 1105. The batch of changes to all objects may then be applied as a second batch update operation. Those skilled in the art will recognize that the second batch update operation may be optimized based on the characteristics of the search index operation. For example, a bulk updated operation on a search index represented using subindexes as described in U.S. patent application Ser. No. 12/022,073 may be optimized so that custom transformers are only generated on each subindex for fields modified in that subindex.

In embodiments, the custom transformer generated for an inherited field of an object depends on whether the inherited field supports source facets 1110. If an inherited field supports source facets, the source facets are used to segregate its inherited values based upon whether the source (ancestor or descendant) is an upward source or a downward source 1115. The same transforms that were applied to an inherited value in the upward or downward source field are applied to the value in the inherited field 1120. If an inherited field does not support source facets, each transformer applied to the field on any of the source objects (ancestors or descendants, depending on the type of inherited field) is also applied to the inherited field values 1125. For example, if values are only added to sources, then all values added to any source also are added to the inherited field. If values are deleted, then delete is unconditional on the inherited values because specific sources for each value are not specified.

Steps 910-925 of method 900 may be implemented by embodiments of update propagator 415 in embodiments of system 400. In various embodiments of the invention, method 900 represents a push-based inheritance propagation scheme that may be performed in two passes: 1) Apply updates to existing objects and build a representation of inheritance consequences (steps 905-915); and 2) Generate a second batch of updates representing inheritance consequences and apply the second batch of updates (steps 920-925).

E. Computing System Implementations

It shall be noted that the present invention may be implemented in any instruction-execution/computing device or system capable of processing the image data, including without limitation, a general-purpose computer and a specific computer, such as one intended for graphics processing. The present invention may also be implemented into other computing devices and systems, including without limitation, a digital camera, a printer, a scanner, a multiple function printer/scanner, a facsimile machine, a multimedia device, and any other device that processes, captures, transmits, or stores an image. Furthermore, within any of the devices, aspects of the present invention may be implemented in a wide variety of ways including software, hardware, firmware, or combinations thereof. For example, the functions to practice various aspects of the present invention may be performed by components that are implemented in a wide variety of ways including discrete logic components, one or more application specific integrated circuits (ASICs), and/or program-controlled processors. It shall be noted that the manner in which these items are implemented is not critical to the present invention.

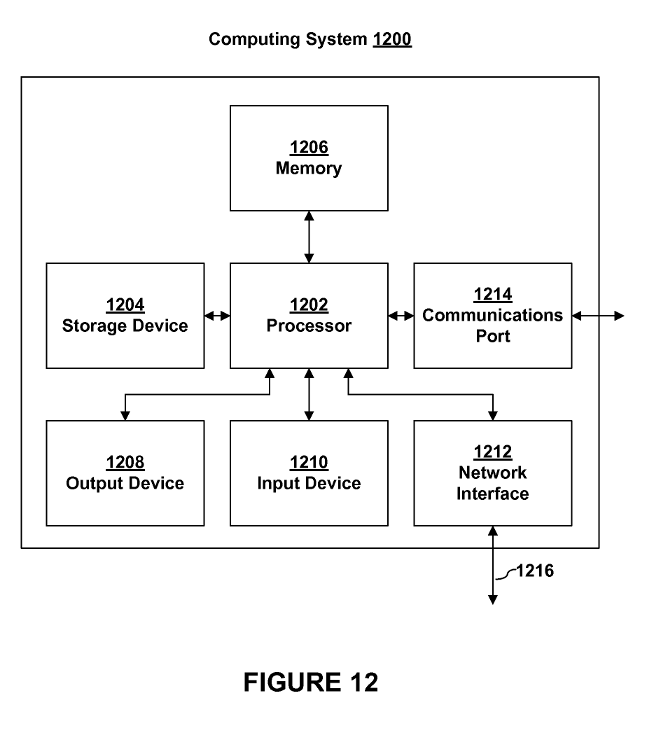

FIG. 12 depicts a functional block diagram of an embodiment of an instruction-execution/computing device 1200 that may implement or embody embodiments of the present invention. As illustrated in FIG. 12, a processor 1202 executes software instructions and interacts with other system components. In an embodiment, processor 1202 may be a general purpose processor such as an AMD processor, an INTEL x86 processor, a SUN MICROSYSTEMS SPARC, or a POWERPC compatible-CPU, or the processor may be an application specific processor or processors. A storage device 1204, coupled to processor 1202, provides long-term storage of data and software programs. Storage device 1204 may be a hard disk drive and/or another device capable of storing data, such as a computer-readable media (e.g., diskettes, tapes, compact disk, DVD, and the like) drive or a solid-state memory device. Storage device 1204 may hold programs, instructions, and/or data for use with processor 1202. In an embodiment, programs or instructions stored on or loaded from storage device 1204 may be loaded into memory 1206 and executed by processor 1202. In an embodiment, storage device 1204 holds programs or instructions for implementing an operating system on processor 1202. In one embodiment, possible operating systems include, but are not limited to, UNIX, AIX, LINUX, Microsoft Windows, and the Apple MAC OS. In embodiments, the operating system executes on, and controls the operation of, the computing system 1200.

An addressable memory 1206, coupled to processor 1202, may be used to store data and software instructions to be executed by processor 1202. Memory 1206 may be, for example, firmware, read only memory (ROM), flash memory, non-volatile random access memory (NVRAM), random access memory (RAM), or any combination thereof. In one embodiment, memory 1206 stores a number of software objects, otherwise known as services, utilities, components, or modules. One skilled in the art will also recognize that storage 1204 and memory 1206 may be the same items and function in both capacities. In an embodiment, one or more of the components of FIGS. 4A through 4C may be modules stored in memory 1204, 1206 and executed by processor 1202.

In an embodiment, computing system 1200 provides the ability to communicate with other devices, other networks, or both. Computing system 1200 may include one or more network interfaces or adapters 1212, 1214 to communicatively couple computing system 1200 to other networks and devices. For example, computing system 1200 may include a network interface 1212, a communications port 1214, or both, each of which are communicatively coupled to processor 1202, and which may be used to couple computing system 1200 to other computer systems, networks, and devices.

In an embodiment, computing system 1200 may include one or more output devices 1208, coupled to processor 1202, to facilitate displaying graphics and text. Output devices 1208 may include, but are not limited to, a display, LCD screen, CRT monitor, printer, touch screen, or other device for displaying information. Computing system 1200 may also include a graphics adapter (not shown) to assist in displaying information or images on output device 1208.

One or more input devices 1210, coupled to processor 1202, may be used to facilitate user input. Input device 1210 may include, but are not limited to, a pointing device, such as a mouse, trackball, or touchpad, and may also include a keyboard or keypad to input data or instructions into computing system 1200.

In an embodiment, computing system 1200 may receive input, whether through communications port 1214, network interface 1212, stored data in memory 1204/1206, or through an input device 1210, from a scanner, copier, facsimile machine, or other computing device.

One skilled in the art will recognize no computing system is critical to the practice of the present invention. One skilled in the art will also recognize that a number of the elements described above may be physically and/or functionally separated into sub-modules or combined together.

It shall be noted that embodiments of the present invention may further relate to computer products with a computer-readable medium that have computer code thereon for performing various computer-implemented operations. The media and computer code may be those specially designed and constructed for the purposes of the present invention, or they may be of the kind known or available to those having skill in the relevant arts. Examples of computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter.

While the invention is susceptible to various modifications and alternative forms, specific examples thereof have been shown in the drawings and are herein described in detail. It should be understood, however, that the invention is not to be limited to the particular forms disclosed, but to the contrary, the invention is to cover all modifications, equivalents, and alternatives falling within the scope of the appended claims.

What is claimed is:

1. A method for updating a search index, the method comprising:
executing a first set of update requests comprising at least one transformation, the first set of update requests identifying a first set of objects to be updated within the search index;
identifying a second set of objects based at least in part on an inheritance relationship with the first set of objects,
associating the at least one transformation with the second set of objects;
generating a second set of update requests comprising the at least one transformation and the second set of objects; and
executing the second set of update requests within the search index.

2. The method of claim 1 further comprising the step of creating a representation based at least in part on the identified second set of objects and the at least one transformation, wherein the representation comprises:
a universe set comprising a first object, related through inheritance to an updated object within the first set of objects, the first object including an inherited field to be modified;
an upward sources set comprising a second object within the first set of objects, the second object including a first modified field that is inherited by at least one ancestor object; and
a downward sources set comprising a third object within the first set of objects, the third object including a second modified field that is inherited by at least one descendant object.

3. The method of claim 1 wherein the step of generating the second set of update requests comprises building a transformer for an inherited field of at least one object within the second set of objects.

4. The method of claim 3 wherein the transformer is constructed for a value within the inherited field, the value being identified by a source facet pointing to an object within the first set of objects.

5. The method of claim 3 wherein the transformer is constructed for the inherited field, the transformer being constructed based on a prior transformer associated with a field within an object in the first set of objects.

6. The method of claim 3 wherein the search index comprises a plurality of subindexes and the at least one object is in a subindex within the plurality of subindexes.

7. The method of claim 6 wherein the transformer for the at least one object is associated with the subindex.

8. A computer readable medium having instructions for performing the method of claim 1.

9. A method for updating a search index, the method comprising:
accessing an object having a field to-be-updated;
identifying a plurality of objects within the search index, the plurality of objects having a first set of common fields with the field to-be-updated;
determining a set of source objects within the plurality of objects, the set of source objects having an inheritance relationship with the accessed object and a second set of fields common with the field to-be-updated; and
modifying the field to-be-updated based on values within the second set of fields.

10. The method of claim 9 wherein the step of determining the set of source objects comprises examining a source objects field within the accessed object.

11. The method of claim 10 wherein a value in the source objects field is a unique identifier of a source object having an inheritance relationship with the accessed object.

12. The method of claim 9 wherein the search index comprises a plurality of subindexes.

13. A computer readable medium having instructions for performing the method of claim 9.

14. A method for adding an inheritance relationship between a first object and a second object within a search index, the method comprising:
copying a first field and value within the first object to a second field within the second object; and
creating an inheritable field in the second object, the inheritable field identifying an inheritance relationship between the first field and the second field.

15. The method of claim 14 wherein the first object is a tree comprising a third object and a fourth object with an inheritance relationship between the third object and the fourth object.

16. The method of claim 15 wherein the third object also has an inheritance relationship with the second object.

17. A computer readable medium having instructions for performing the method of claim 14.

18. A method for removing an inheritance relationship between a first object and a second object within a search index, the method comprising:
removing a first field from the first object, the first field having been inherited from a second field within the second object; and
removing an inheritable field in the first object, the inheritable field identifying an inheritance relationship between the first field and the second field.

19. The method of claim 18 wherein removing the inheritance relationship comprises removing a value from the first field and from the inheritable field, the value having been inherited from the second object.

20. The method of claim 19 wherein the value within the inheritable field is associated with a source facet that identifies the second object.

21. A computer readable medium having instructions for performing the method of claim 18.

22. A method for applying a modification to a first field of a first object within a search index, the method comprising:
applying the modification to the first field;
determining an inheritance relationship between the first field and a second field within a second object within the search index by examining an inheritable field within the first object, the inheritable field being associated with the first field; and
applying the modification to the second field.

23. The method of claim 22 wherein the modification is adding a value to the first field.

24. The method of claim 22 wherein the modification is removing a value from the first field.

25. The method of claim 22 wherein the modification is changing a value within the first field.

26. A computer readable medium having instructions for performing the method of claim 22.

27. A system for updating a search index, the system comprising:
an object updater, coupled to receive an update request, the object updater applying at least one modification to a first object within the search index; and
an update propagator that identifies a set of objects having an inheritance relationship to the first object and a set of modifications comprising the at least one modification, the set of modifications to be applied to at least some of the objects within the set of objects.

28. The system of claim 27 wherein the update propagator is a join query processor that updates the search index by performing a method comprising the steps of:
identifying a field to-be-updated within the first object;
identifying a plurality of objects within the search index, the plurality of objects having a first set of common fields with the field to-be-updated;
determining a set of source objects within the plurality of objects, the set of source objects having an inheritance relationship with the first object and a second set of fields common with the field to-be-updated; and
modifying the field to-be-updated based on values within the second set of fields.

29. The system of claim 27 wherein the update propagator maintains relationships across the set of objects by performing a method comprising the steps of:
executing a first set of update requests comprising at least one transformation, the first set of update requests identifying a first set of objects to be updated within the search index;
identifying a second set of objects based at least in part on an inheritance relationship with the first set of objects,
associating the at least one transformation with the second set of objects;
generating a second set of update requests comprising the at least one transformation and the second set of objects; and
executing the second set of update requests within the search index.

30. A system for maintaining relationships across a plurality of objects within a search index, the system comprising:
a new object inserter that adds an inheritance relationship between a first object and a second object within the search index;
an existing object remover that removes an inheritance relationship between the first object and the second object; and
an inheritable field modifier that applies a modification to a first field of the first object.

31. The system of claim 30 wherein the new object inserter performs a method comprising the steps of:
copying a first field and value within the first object to a second field within the second object; and
creating an inheritable field in the second object, the inheritable field identifying an inheritance relationship between the first field and the second field.

32. The system of claim 30 wherein the existing object remover performs a method comprising the steps of:
removing a first field from the first object, the first field having been inherited from a second field within the second object; and
removing an inheritable field in the first object, the inheritable field identifying an inheritance relationship between the first field and the second field.

33. The system of claim 30 wherein the inheritable field modifier performs a method comprising the steps of:
applying the modification to the first field;
determining an inheritance relationship between the first field and a second field within a second object within the search index by examining an inheritable field within the first object, the inheritable field being associated with the first field; and
applying the modification to the second field.
